(19) United States
(12) Patent Application Publication
(10) Pub. No.: US 2026/0147637 A1
(43) Pub. Date: May 28, 2026

(54) PRECISE PRE-METHOD AND POST-METHOD TASK CREATION AND ADMINISTRATION IN A DISTRIBUTED ENVIRONMENT

(71) Applicant: DELL PRODUCTS L.P., Round Rock, TX (US)

(72) Inventors: Parmeshwr Prasad, Bangalore (IN); Anubhav Singh, Pune (IN)

(21) Appl. No.: 18/916,996

(22) Filed: Oct. 16, 2024

(51) Int. Cl. G06F 9/50

(52) U.S. Cl. CPC G06F 9/5083

(57) ABSTRACT

An information handling system may include a monitoring system to monitor a Kubernetes environment. The monitoring system may configure a custom exporter to scrape metrics from a plurality of targeted pods, and transform the scraped metrics into Prometheus Query Language (PromQL) data for storing. The monitoring system may then select one or more stored metrics associated with a pod to be processed, compare the selected metrics with preconfigured thresholds associated with the pod to be processed, and generate a pre/post method. The pre/post method may include a new configuration of the pod to be processed.

### FIELD OF THE DISCLOSURE

The present disclosure generally relates to distributed systems and, more particularly, to utilization of a monitoring system in a distributed computing environment to create and implement dynamic pre-method and post-method tasks.

### BACKGROUND

As the value and use of information continue to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use, such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

In a distributed computing environment, different pods (or nodes) may require dynamic pre-method and/or post-method tasks to ensure smooth execution of processes, applications, or services. Pre-method tasks may include actions or operations that take place before a specific operation or workflow is executed on a resource, such as a pod or a container. For example, pre-method tasks include computing environment configuration, resource initialization, or input data validation. Post-method tasks may include actions or operations that occur after completion of a core operation, such as deploying the pod. For example, post-method tasks include clean-up, logging, or performing follow-up actions. In an embodiment, a monitoring system in a distributed computing environment may be used to collect and store metrics from targeted pods. The monitoring system may then select one or more stored metrics that are associated with a particular pod to be processed. The selected one or more metrics can be used in a preconfigured algorithm to generate the pre-method and/or post-method tasks (also referred to herein as pre/post method) for the particular pod. The monitoring system then may implement the derived pre/post method on the particular pod to ensure the system's health and continuity.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an example computing environment that utilizes multiple information handling systems according to at least one embodiment of the present disclosure;

FIG. 2 is a block diagram of an example distributed computing environment with an integrated monitoring system to monitor applications, services, and/or infrastructures in the distributed computing environment according to at least one embodiment of the present disclosure;

FIG. 3 is a block diagram of an example custom exporter operation for collecting metrics according to at least one embodiment of the present disclosure;

FIG. 4 is an example of a preconfigured table that may be used to generate a pre/post method according to at least one embodiment of the present disclosure;

FIG. 5 is a flow diagram of a method for monitoring a distributed computing environment to create and administer a dynamic pre/post method according to at least one embodiment of the present disclosure;

FIG. 6 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

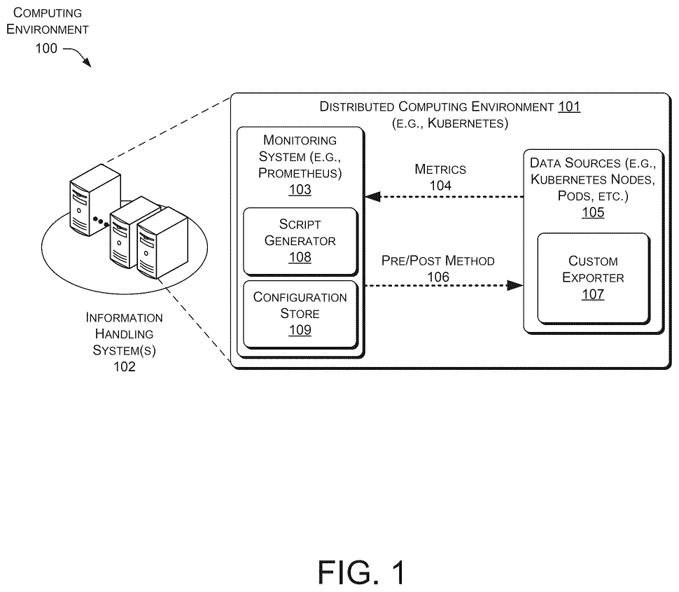

FIG. 1 illustrates an example computing environment 100, according to at least one embodiment of the present disclosure. The computing environment 100 may refer to a collection of hardware, software, and networks that interact to perform and manage computational tasks. In some embodiments, the computing environment 100 includes a distributed computing environment 101 where a workload is spread across multiple information handling system(s) 102, which can be located in different geographical locations. The information handling system(s) 102 may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a particular information handling system 102 may represent a computer system, such as a laptop computer, a desktop computer, a computer workstation, a server system, a blade server system, or other rack-mounted computer equipment, such as a storage server, a network server, a network switch/router, or other datacenter computer equipment, or other electronic equipment generally defined, but being characterized as including a monitoring system 103 (or controller) to collect metrics 104 from data sources 105, and process the collected metrics 105 to generate pre/post method 106 to maintain a robust computing environment. As described herein, the pre/post method may include pre-method tasks, post-method tasks, or a combination thereof, as may be desired.

The distributed computing environment 101 can be a type of computing environment where systems can be configured to solve computational tasks. The distributed computing environment 101 may utilize multiple information handling systems 102, for example, which can be representative of multiple pods (or nodes) that can communicate over a network (e.g., LAN, WAN, or internet) to perform the computational tasks in a coordinated manner. For purposes of illustration, the distributed computing environment 101 includes a Kubernetes environment with an integrated monitoring system 103 (i.e., controller) to automatically discover and monitor pods, nodes, services, and other data sources 105 at different levels or stacks in the Kubernetes environment. Kubernetes is an open-source project that provides an open-source container orchestration platform for automating deployment, scaling, and management of containerized applications.

In an embodiment, the monitoring system 103 can be a Prometheus monitoring system that may be configured to collect and store metrics 104 from the data sources 105 via a custom exporter 107. The data sources 105 may include services, applications, and/or infrastructures in one or more levels or stacks in a Kubernetes environment. The custom exporter 107 may be configured to scrape raw data from targeted data sources 105, transform the scraped raw data into Prometheus Query Language (PromQL) data that can be understood by the (Prometheus) monitoring system 103, and transmit the PromQL data as metrics 104 to the monitoring system 103. The scraping of raw data and/or transmission of the PromQL data may be in response to a query, performed at the end of a time period, or based upon an occurrence of an event. For example, the custom exporter 107 may automatically push short-lived application metrics to the monitoring system 103 or transmit only the PromQL data in response to a received query. In another example, the custom exporter 107 may transmit latency values (i.e., metrics) in response to an occurrence of an event, such as a detected high disk usage. In these examples, the custom exporter 107 may scrape the desired metrics just before the transmission of the PromQL data, upon receiving of a query, or upon an occurrence of an event.

In some embodiments, the monitoring system 103 may collect the metrics 104 from the one or more targeted applications in the pods or nodes, and store the scraped metrics in a time-series database or datastore (not shown). In these embodiments, the monitoring system 103 may use PromQL to query and analyze the collected metrics 104 for system performance. The monitoring system 103 may further utilize a script generator 108 and a configuration store 109 in analyzing the collected metrics 104 to dynamically generate the pre/post method 106.

Script generator 108 may include hardware, software, or a combination thereof, that can be configured to generate the pre/post method 106. The script generator 108 may utilize an algorithm to dynamically generate script templates, and inject relevant parameters or commands based on trigger conditions and the specific requirements of each application, service, or infrastructure in the distributed computing environment 101. The trigger conditions and specific requirements may be stored as preconfigured rules/conditions (not shown) in the configuration store 109. In some embodiments, the script generator 108 may act as a controller that performs preconfigured pre-method or post-method tasks (not shown) that correspond to the stored preconfigured rules/conditions. Different preconfigured pre-method or post-method tasks may be associated with different pods and rules/conditions.

For example, a particular alert corresponds to a task that uses an algorithm to determine the pre/post method 106. The algorithm, for example, combines a base pre/post method and a derived pre/post method. In this example, the base pre/post method may include pre-configured pre-method and/or post-method tasks that can be implemented on the distributed computing environment 101 at any given time as may be preconfigured. On the other hand, the derived pre/post method may include the pre-method and/or post-method tasks that can be determined based upon the values and/or labels of the collected metrics 104. By combining the base pre/post method and the derived pre/post method, the script generator 108 may generate the pre/post method 106 to dynamically adjust the configuration of the targeted pod or pods. The pre/post method 106 may include pre-method tasks, post-method tasks, or a combination thereof.

In another example, a particular condition corresponds to a task that specifies a termination of an application and reporting of the associated metrics to a user (not shown). The particular condition and the corresponding tasks are stored in the configuration store 109. In this example, the script generator 108 may select the associated metrics from the stored PromQL data and generate the pre/post method 106 for the termination of the application and the reporting of the selected metrics. The generated pre/post method 106 may also include instructions for the custom exporter 107 to stop collecting the values of the associated metrics.

The configuration store 109 may store pre-configured rules or conditions and associated tasks for these rules or conditions. Preconfigured rules or conditions may include events that can trigger the scraping and selection of the metrics 104, preconfigured threshold values to be observed in performing a task, a particular type of algorithm to be used, particular labels or detected settings to perform another task, and other parameters that can be used as conditions for performing corresponding tasks. The pre-configured rules or conditions may utilize user-input values, user-input alert rules, and other user-input settings that can be used to identify the corresponding tasks or pre/post method operations.

Pre/post method 106 may include actions or tasks that can be implemented before and/or after an execution of specific operations, deployment of services, or activation of an infrastructure in the distributed computing environment 101. In Kubernetes environment, the pre-method operations may include preparation of the computing environment to ensure the running of the main process, such as starting a container or deploying a pod. For example, the pre-method operations may include resource validation to ensure that the pod specifications are valid, configuration setup that includes loading of ConfigMaps before the pod starts, scheduling to determine which node will run based on node capacity, and the like.

The post-method operations may include the actions or tasks that can be implemented after the main or desired process in the Kubernetes environment has been executed. For example, the post-method operations may include cleanup tasks, status reporting, or notifications to signify the completion or execution of an operation. As described herein, the pre/post method 106 may include the pre-method operations, post-method operations, or a combination thereof, to dynamically adjust the configurations and/or parameters of the deployed applications, services, infrastructure, and other cluster components that are involved in Kubernetes operations.

In some embodiments, the monitoring system 103 (or controller) may be deployed as a pod or set of pods in the Kubernetes environment (distributed computing environment 101). The monitoring system 103 may be integrated with the Kubernetes environment to automatically discover the nodes, pods associated with the nodes, services, and other Kubernetes resources. For example, the monitoring system 103 may be deployed as pods to collect the metrics 104 from the data sources 105 via the custom exporter 107. The custom exporter 107 may collect and transmit the collected metrics 104 to the monitoring system 103 after a time period, at a periodic interval, or upon an occurrence of an event or condition. Here, the custom exporter 107 may transform the scraped raw data from targeted nodes into PromQL data (i.e., metrics 104), and the transmitted PromQL data are then stored in the datastore (not shown) of the monitoring system 103.

The monitoring system 103 may then select the stored one or more stored metrics associated with the targeted pod or pods to be processed. The processing, for example, may include adjusting the current configurations of the targeted pods. In some embodiments, the script generator 108 may use one or more selected metrics in an algorithm to determine the pre/post method 106, which can be used as a reference for adjusting the current configurations of the targeted pod or pods. The pre/post method 106 may be implemented on the targeted pods to efficiently manage the associated applications, services, and/or infrastructures.

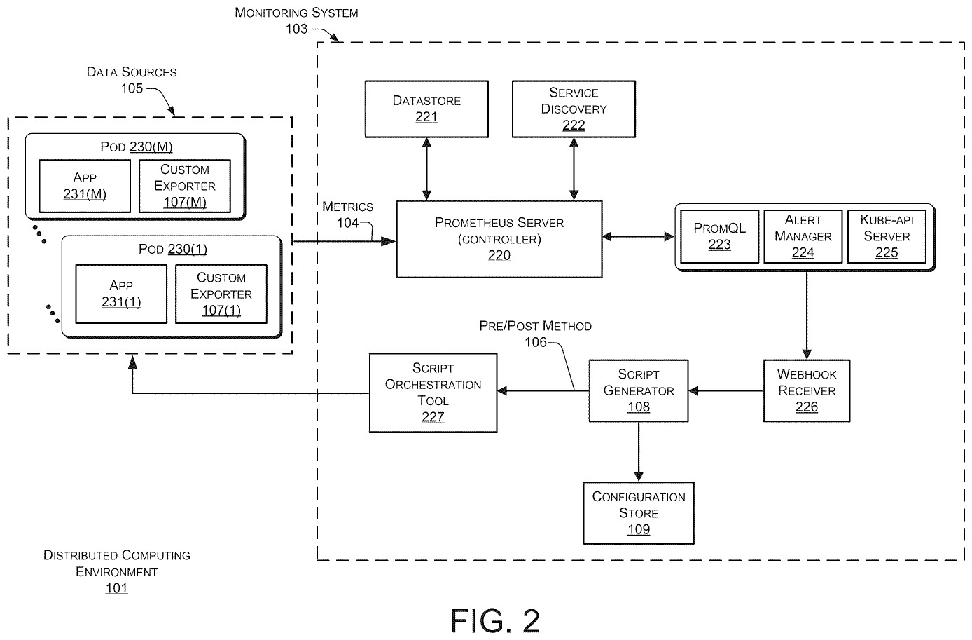

FIG. 2 illustrates an example block diagram of the distributed computing environment 101 with an integrated monitoring system 103 to monitor applications, services, and/or infrastructures in the distributed computing environment according to at least one embodiment of the present disclosure. The distributed computing environment 101 may include the monitoring system 103 that can receive the selected metrics 104 from the targeted data sources 105. The monitoring system 103 may include, for example, the Prometheus monitoring system, while the data sources 105 can be representative of the targeted nodes or clusters in the Kubernetes environment. The monitoring system 103 may be integrated with the Kubernetes environment to monitor the applications, services, infrastructures, and other processes in the distributed computing environment 101. Based on the monitored metrics 104, the monitoring system 103 may generate the pre/post method 106 to dynamically adjust settings or configurations of the targeted applications, services, and/or infrastructures in the data sources 105.

In some embodiments, the monitoring system 103 may include a Prometheus server 220 (or controller), datastore 221, service discovery 222, PromQL 223, alert manager 224, kube-api server 225, Webhook receiver 226, script generator 108, configuration store 109, and a script orchestration tool 227. The data sources 105 may include pods 230(1)-230(M), custom exporters 107(1)-107(M), and applications 231(1)-231(M). Although the custom exporters 107(1)-107(M) were presented to be included in the data sources 105, the custom exporters can be treated as internal components of the monitoring system 103. As an operation overview, the monitoring system 103 may use the custom exporters 107 to collect the metrics 104, and the collected metrics can be used by the script generator 108 to generate the pre/post method 106. Thereafter, the script orchestration tool 227 may implement the pre/post method 106 on the applications, services, and/or infrastructures associated with the targeted pods 230(1)-230(M). The targeted pods 230 are also referred to herein as targeted nodes.

Each of the pods 230(1)-230(M) (also referred to herein as pods 230) may include a unit of deployment in the Kubernetes environment. For example, when an application 231 is deployed in Kubernetes, the application 231 can be deployed in one or more pods 230, either directly or through higher-level abstractions like StatefulSets. The pods 230 may be created, destroyed, and recreated by Kubernetes based on the needs of the deployed application 231. Further, one or more pods 230 may be deployed or hosted by a node (not shown), which can be a physical or virtual machine that runs Kubernetes workloads. In some embodiments, each of the pods or nodes may include a hardware that can be reconfigured based on the generated pre/post method 106. For example, each of the pods 230 may include one or more containers (not shown) that package the application 231 and its dependencies. In this example, the node, via its node agent, may be reconfigured for managing the applications 235 running with the associated pods 230.

Each of the custom exporters 107(1)-107(M) (also referred to herein as custom exporters 107) may include a piece of software that is specifically designed and configured to collect metrics 104 from a particular application, service, or system. The collection can be initiated by a query, automatic detection by the corresponding exporter, or in response to the detection of an alert or occurrence of an event. In the context of the illustrated Prometheus monitoring system in the Kubernetes environment, each of the custom exporters 107 may include a tool or process that exposes specific metrics or parameters from the applications 231 in the corresponding pods 230. For example, the Prometheus server 220 collects the metrics 104 through HTTP endpoints (not shown) in a particular format. In this case, the custom exporters 107 may translate the collected metrics 104 in a manner compatible with the Prometheus server 220. In some embodiments, the Prometheus server 220 may scrape targeted pods 230 for the metrics 104 that can be exposed by the corresponding custom exporters 107 at regular intervals, a preconfigured time period, the presence of an alert or triggering condition, or a combination thereof. In this regard, the collection of the metrics 104 may be performed as requested and not necessarily in a continuous manner.

Datastore 221 may include a repository of collected metrics 104 (also referred to herein as PromQL data) that were automatically pushed by the corresponding custom exporters, or transmitted by the custom exporters in response to a received query. Depending upon a specific application or system that is being monitored, the collected metrics 104 may include system metrics, custom metrics, and/or application-specific metrics. The system metrics may include without limitation a CPU usage (e.g., CPU utilization, idle time, workload), memory usage (e.g., total memory, free memory, swap usage), disk usage (e.g., disk space used, disk I/O rate), and a network usage such as packet loss or amount of network traffic. The custom metrics may include application-specific counters (e.g., number of scraped errors, number of successful operations), gauges (e.g., current number of active connections), and histograms such as distribution of request latency. The application-specific metrics may include HTTP request metrics (e.g., number of requests), database metrics (e.g., query execution time, connection pool usage), queue metrics (e.g., processing time, error rate), and custom business metrics such as sales data and conversion rates).

In an embodiment, the datastore 221 may store an unstructured collection of metrics 104 that can be accessed and further filtered by the script generator 229. The stored metrics 104 may include the PromQL data that can be selected for use in a script generator algorithm (not shown) to determine the pre/post method 106, which can be representative of a determined current pre/post method task. For example, an algorithm for determining the current pre/post method may combine the base pre/post method and the derived pre/post method. In this example, the base pre/post method may include tasks that may be implemented by the script orchestration tool 227 without condition or regard to the collected metrics 104, while the derived pre/post method may be determined based on the selected stored metrics 104 in the datastore 221.

In some embodiments, the selected stored metrics 104 may include time-series data where measurements are collected over time. In these embodiments, time-series data may include corresponding timestamps, values, and labels. These parameters of the selected time-series data may be used by the script generator 229 to track changes in the configuration of the system, identify trends, and make predictions.

For example, the selected stored metrics 104 for a particular application include a timestamp. Here, the associated timestamp may be used to trigger deletion, pausing, running of the application, or performance of a particular preconfigured task.

In Prometheus monitoring system, the service discovery 222 may represent a process of automatically discovering and registering services within the distributed system. This process may enable the Prometheus server 220 (or controller) to monitor and collect the metrics 104 from the pods or services without manual configuration. For example, the Prometheus server 220 may automatically detect new services in the Kubernetes cluster as they are added to the distributed system and further remove these services when they are no longer available or required. In this example, the service discovery 222 may allow efficient and scalable monitoring by the Prometheus server 220.

Prometheus server 220 may include hardware, software, or a combination thereof, for collecting, storing, and querying time-series metrics 104 from targeted applications or services. The Prometheus server 220 may represent the controller or core component of the monitoring system 103, and can be operated independently without relying on distributed storage systems or third-party services, making it robust for the monitoring system. In some embodiments, the Prometheus server 220 may utilize the PromQL 223 as a query language to extract the metrics 104 from the pods 230. The Prometheus server 220 may use the PromQL 223 to filter, aggregate, and visualize time series data based on time ranges, intervals, and trends. For example, the PromQL 223 uses labels to filter and group the time series data and thereby, facilitating isolation of specific subsets of data. In another example, the PromQL 223 supports vector math operations, allowing the combination or comparison between the time series data.

Alert manager 224 may include a component of the monitoring system 103 to handle alerts and notification of users or systems about the alerts. As described herein, alerts may include events that can be used to trigger another process or operation such as, without limitation, deployment of another application in the pods 230, pausing the collection of metrics 104, configuration of the datastore 221, scraping of raw data, pushing of scraped raw data, transmission of metrics, and the like. The conditions for the alert rules may be predefined, and when the conditions are satisfied, the alert manager 224 may manage alert routing, deduplication, grouping, and notification delivery such as via email. The alert rules, conditions, and corresponding tasks may be stored in the configuration store 109.

Kube-api server 225 may represent the front-end for the Kubernetes API, which may expose metrics that can be collected by the Prometheus server 220. For example, the Prometheus server 220 may be configured to scrape metrics 104 from the Kube-api server 225 that stores and manages desired state of the Kubernetes resources. In this example, the Kube-api server 225 is responsible for handling the API requests from the Prometheus server 220.

Webhook receiver 226 in a Kubernetes environment may refer to an endpoint that can be used with the alert manager 224 to listen for incoming webhook requests. A webhook may include a method of sending real-time data from one application to another over HTTP upon an occurrence of an event. The webhook receiver 226 may receive webhook data, for example, and then send alerts to the script generator 108 in response to receiving of the webhook data.

Script generator 229 may include a hardware, software, or a combination thereof, that can be configured to generate the pre/post method 106. In an embodiment, the script generator 229 may utilize an algorithm to dynamically generate script templates, and inject relevant parameters or commands based on trigger conditions and the specific requirements of each application 231 in the corresponding pods 230. In this embodiment, the algorithm may determine the pre/post method 106 by combining a base pre/post method and a derived pre/post method. The base pre/post method may include pre-configured pre-method and/or post-method tasks that can be implemented on the pods 230 regardless of the metrics that were collected and stored in the datastore 221. The derived pre/post method may include the pre-method and post-method tasks that can be based upon the selected metrics from the datastore 221. The pre-configured pre-method and post-method tasks, the conditions that can trigger the selection of the metrics, the algorithms that can be used to generate the current pre/post method 106, and similar data may be stored in the configuration store 109.

The configurations store 109 may store rules or conditions such as settings, labels, algorithms to be used, threshold values to be utilized, and other parameters for generating script templates that can be represented by the pre/post method 106. In some embodiments, the configurations store 109 may store different tasks such as pre-script parameters and post-script parameters.

Without limitation, the pre-script parameters may include: 1) initialization parameters such as application name, environment variables, resource application, and dependency initialization; 2) configurations parameters such as logging configuration, health checks, data backup or initialization; 3) preparation tasks such as resource allocation, dependency initialization, and data backup or initialization; and 4) notification configuration such as alerting mechanisms for any pre-execution events or conditions. The post-script parameters may include: 1) cleanup tasks such as releasing resources, deleting temporary files, or performing post-processing actions on generated data; 2) finalization tasks such as data cleanup, finalization of application state, or resetting environment variables; 3) logging and reporting tasks such as final logging configuration, reporting the completion status, or triggering notifications or alerts for post-execution events or conditions; and 4) notification configuration such as setup notifications or alerting mechanisms for any post-execution events or conditions.

Script orchestration tool 227 may implement the generated script templates that correspond to the pre/post method 106. The script orchestration tool 227 may control system updates, deployment of additional applications, and implement instructions for pre-method and/or post-method tasks from the generated pre/post method 106. For example, the pre/post method 106 includes performing a Lifecycle Management (LCM) termination stage for a particular pod. The LCM may refer to the process of managing different stages of the pods 230 throughout its lifecycle, from creation to termination. In this example, the script orchestration tool 227 may receive the instructions in the pre/post method 106 that can include the termination of the deployment of the particular pod. In another example, the pre/post method 106 may include instructions to change configurations of the custom exporter associated with a targeted pod. In this example, the script orchestration tool 227 may transmit the new configurations and other instructions for the custom exporter 107, and so on. The pre/post method 106 may optimize, without limitations, implementations of updating cluster node status, utilization of CPU cores, network route design, rest api check, firmware version updates, mandatory app dependencies, network throughput, duplicating IP, link speed, link status, and other system component checking.

In some embodiments, the script orchestration tool 227 may be configured to validate the pre/post method 106 to ensure accuracy of the intended actions. By integrating with the script orchestration tool 227 with the script generator 108, script execution alongside the other deployment tasks may provide cohesion, reliability, and efficiency in the deployment process. Further, the unique custom exporters 107 for each application or service may be configured depending on data such as error, workload, dependencies, environment change, forecasted configuration, and the like. Here, the monitoring system 103 may gather and store time-series data for analysis and alerting by acting as a bridge between the targeted pods 230 and the corresponding custom exporters 107.

In an embodiment, the Prometheus server 220 may configure the custom exporter 107 to gather specific parameters and metadata of the targeted pods at different levels of a stack, and to transform the gathered parameters and metadata into PromQL data (i.e., metric 104) before transmitting the same to the monitoring system 103 for storing at the datastore 221. The stored PromQL data may include a sequence of timestamped values that can be tracked over time, allowing the Prometheus server 220 or the script generator 108 to query specific metrics across a given timeframe. The stored PromQL data at the datastore 221 may include labels, which are key-value pairs that can provide additional context or dimensions to the stored PromQL data. In some embodiments, additional labels, such as timing of deployment, conditions that trigger deployment, and the like, can be added to the PromQL data to improve tracking.

In an embodiment, the custom exporter 107 may be configured to label the transformed raw data to generate the PromQL data, which can be used to analyze applications current state, ongoing operation, dependency, and an overall status of the deployed applications 231. An example code snippet that can be used in the custom exporter 107 to create and label time-series data is shown below:

| | |
|---|---|
| 1. | Define a monitoring system gauge metric for application metrics. |
| 2. | Register the metrics with (Prometheus) monitoring system. |
| 3. | Start a thread to fetch the metrics periodically. In the thread: |
| | - Fetch the application metrics from the application. |
| | - Set the values of the monitoring system metrics. |
| | - Observe a fixed interval of time before fetching the metrics again. |
| | - Http traffic |
| | - pre and post method logs |
| 4. | Serve the metrics on a port. |
| 5. | Define functions to the application metric from the application. |

In the above example code snippet, the “gauge” may include a Prometheus metric type that can represent a single numerical value, which can go up or down (e.g., memory usage, application usage, temperature, etc.). A defined “gauge” can be representative of a labeled metric 104, and multiple “gauges” (or labels) for different corresponding metrics 104 can be defined for purposes of scraping metrics from the data sources 105. The “gauge” may be registered in a Prometheus client library (monitoring system 103), and a thread may run in the background where custom functions can periodically fetch relevant application metrics (e.g., Http traffic). For example, the labeled gauges (metrics 104) can be fetched after a particular time period or at a regular interval. The custom functions can also update the metric values that are stored as PromQL data in the data store 221. In some embodiments, the configured custom exporter 107 may utilize the PromQL 223 to convert the scraped raw data into time-series data, which the Prometheus server 220 can break down to analyze various associated parameters.

With the stored metrics 104 in the datastore 221, the script generator 108 may be configured to generate the pre/post method 106 using selected one or more metrics 104 from the datastore 221. For example, the script generator 108 receives an alert from the alert manager 224 that a particular node (not shown) is to be monitored at a particular time period. In response to the received alert, the script generator 108 may select the one or more metrics 104 that are associated with the particular node. The script generator 108 may then use the selected one or more metrics in an algorithm, for example, to generate the desired pre/post method 106 for the particular node. The algorithm may include comparison with preconfigured threshold values, or include using user-input equations stored in the configuration store 109.

In another example, the script generator 108 may receive from the alert manager 224 an occurrence of a condition such as the deployment of a new application in the pods 230. In response to the received alert, the script generator 108 may similarly select the one or more metrics 104 that might be affected by the deployment of the new application. In this example, the script generator 108 may then use the selected one or more metrics in an algorithm, for example, to generate the desired pre/post method 106 for the affected nodes.

In another example, the script generator 108 may receive an alert for the termination of an application in a particular pod 230 and deletion of associated stored metrics. In response to the received alert, the script generator 108 may similarly select the one or more associated metrics 104 to be deleted. The script generator 108 may generate the pre/post method 106 that includes deletion of the particular pod 230 and instructions to the custom exporter 107 to stop collecting time-series data related to the deleted metrics.

In another example, the script generator 108 may use a sequence of monitoring the pods 230 for reconfiguration based upon a user-input sequence stored in the configuration store 109. The script generator 108 may initiate the generation of the pre/post method 106 at a particular time period or based upon an alert from the alert manager 224. The script generator 108 may similarly select the one or more associated metrics 104 associated with pods to be monitored and use the selected metrics based upon the desired sequence of monitoring the pods, for example. The script generator 108 may then generate the corresponding pre/post method 106 that can be used to sequentially reconfigure the pods 230.

In the above examples, the script orchestration tool 227 may receive the pre/post method 106 and control the implementations on the pods 230 as may be desired.

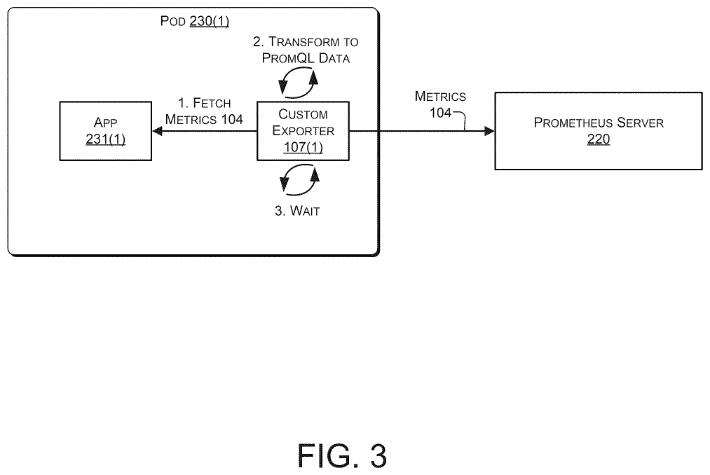

FIG. 3 illustrates an example collection of metrics by the custom exporter according to at least one embodiment of the present disclosure. In some embodiments, the custom exporter 107(1) of the first pod 230(1) may be configured to fetch the metrics 104 from the first application 231(1). The custom exporter 107(1) may transform the fetched metrics 104 into PromQL data before transmitting the transformed metrics to the Prometheus server 220. The custom exporter 107(1) may be configured to perform another fetching of the metrics 104 after a particular wait period. In some cases, the custom exporter 107(1) may be configured to perform the fetching of the metrics 104 and/or transmission of the PromQL data based upon an occurrence of an event or condition as discussed above.

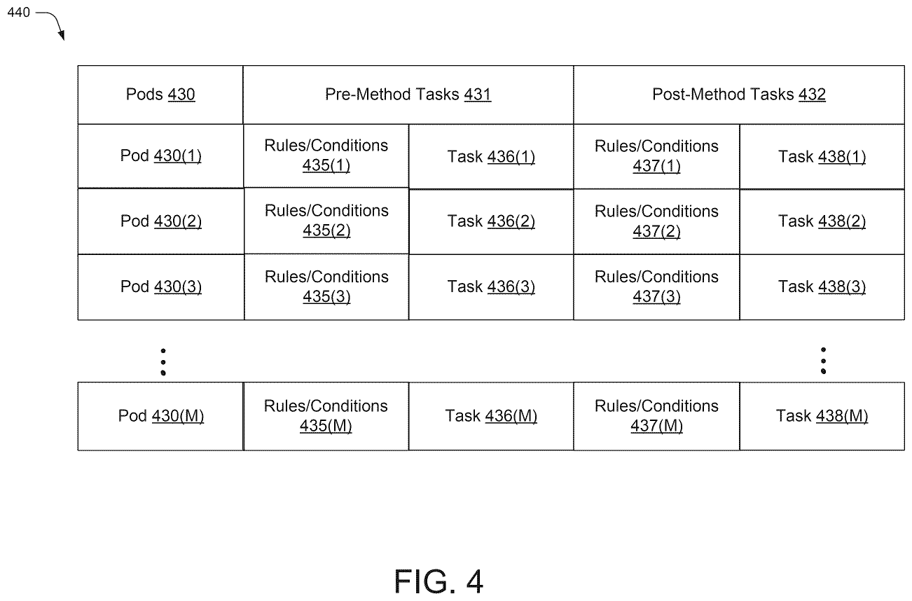

FIG. 4 illustrates an example preconfigured table 440 that can be stored in the configuration table 109 according to at least one embodiment of the present disclosure. In some embodiments, the script generator 108, as shown in FIGS. 1-2, may use the preconfigured table 440 as a reference to generate the pre/post method 106. The preconfigured mapping table 440 may include user-input data and/or other data that can be taken from open sources. The script generator 108 may further use the stored metrics (PromQL data) in the datastore 221 to generate the pre/post method 106.

In an embodiment, the preconfigured mapping table 440 may include pods 430(1)-430(M), pre-method tasks 431, and post-method tasks 432. The pre-method tasks 431 may further include rules/conditions 435(1)-435(M) and corresponding tasks 436(1)-436(M). The post-method tasks 432 may further include rules/conditions 437(1)-437(M) and corresponding tasks 438(1)-438(M). The 430(1)-430(M) correspond to the pods 230(1)-230(M) of FIG. 2.

In some embodiments, each of the rules/conditions 435(1)-435(M) and 437(1)-437(M) may include preconfigured parameters, thresholds, conditions, or other settings that can be used as a reference or triggering event to perform the corresponding tasks 436(1)-436(M) and 438(1)-438(M). Different rules/conditions may be associated with each of the pods 430(1)-430(M). Further, the rules/conditions for the pre-method tasks 431 may be separated from the rules/conditions for the post-method tasks 432. The script generator 108 may use queries or the type of alert from the alert manager when selecting the tasks to be performed and the stored metrics to be utilized in the tasks.

For example, the script generator 108 may receive an alert for the targeted pod 430(1). The script generator 108 may then use the rules/conditions 435(1) to determine the necessary metrics to be utilized. The script generator 108 may then select the determined one or more metrics from the datastore to be used in performing the corresponding task 436(1). Without limitation, task 436(1) can be performance of an algorithm, deployment of an application, termination of running of the application, monitoring another metric, and the like. In some embodiments, the script generator 108 may sequentially perform the tasks in the preconfigured mapping table 440. Further, the script generator 108 may generate the pre/post method that can include the combinations of the tasks 436(1)-436(M) and 438(1)-438(M).

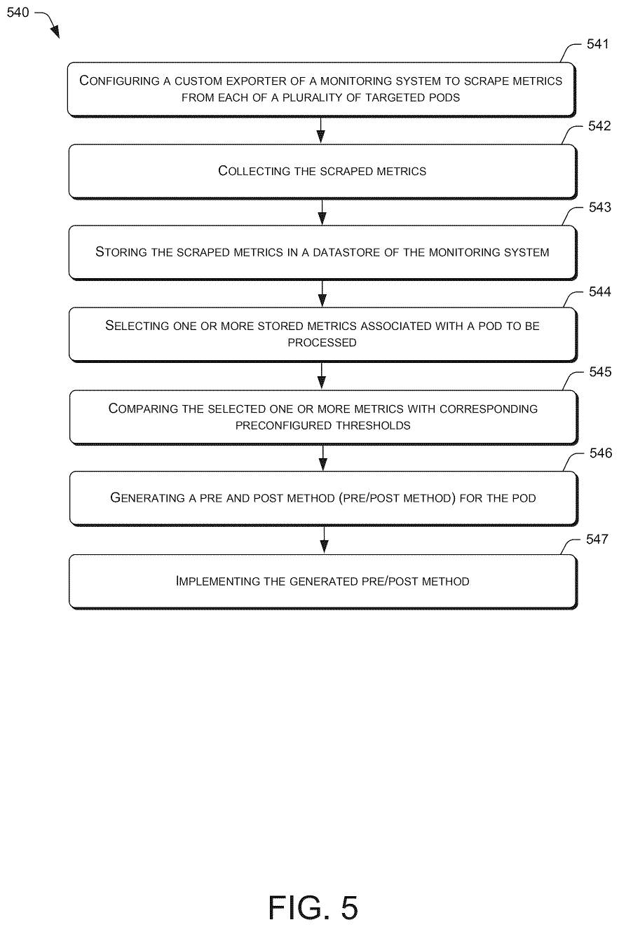

FIG. 5 is a flow diagram of a method 540 for monitoring a distributed computing environment to create and administer the dynamic pre-method and post-method tasks according to at least one embodiment of the present disclosure, starting at step 541. It will be readily appreciated that not every method step set forth in this flow diagram is always necessary, and that certain steps of the methods may be combined, performed simultaneously, in a different order, or perhaps omitted, without varying from the scope of the disclosure. FIGS. 1-2 may be employed in whole, or in part, by a controller (monitoring system) of the information handling system 102 of FIG. 1, or any other type of controller, device, module, processor, or any combination thereof, operable to employ all, or portions of, the method of FIG. 5.

At step 541, the controller may configure a custom exporter to scrape metrics from each of a plurality of targeted pods in a distributed computing environment. For example, the controller may include the Prometheus server or the script generator that can configure dynamically the custom exporter during the operation to generate the pre/post method.

At step 542, the controller may collect the scraped metrics from each of the plurality of targeted pods. In some embodiments, the scraped metrics may include PromQL data.

At step 543, the controller may store the collected metrics in the memory. For example, the collected PromQL data are stored in the datastore.

At step 544, the controller may select one or more stored metrics associated with a pod to be processed.

At step 545, the controller may compare the selected metrics with corresponding preconfigured thresholds associated with the pod to be processed. In some embodiments, different preconfigured thresholds are stored as rules/conditions in the configuration store 109.

At step 546, the controller may generate a pre/post method for the pod to be processed.

At step 547, the controller may implement the generated pre/post method on the pod.

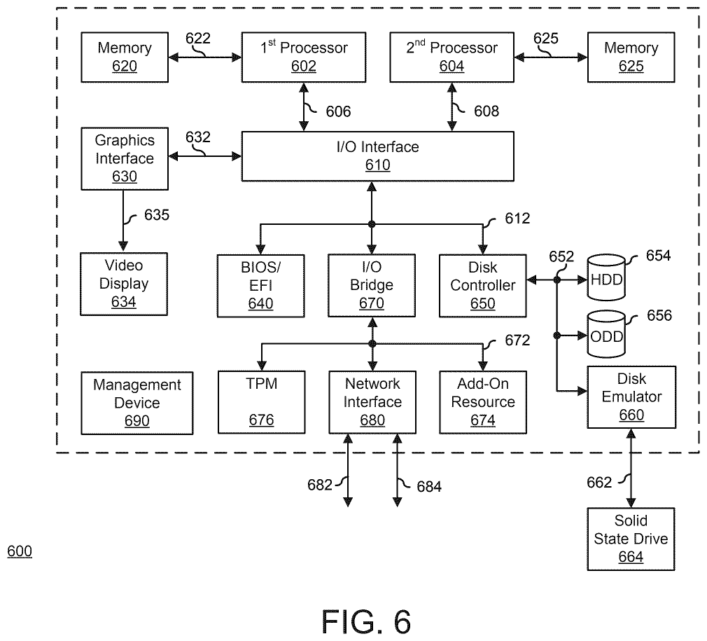

FIG. 6 shows a generalized embodiment of an information handling system 600 according to an embodiment of the present disclosure. Information handling system 600 may be substantially similar to information handling system 102 of FIG. 1 that implements the monitoring system 103. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 600 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 600 can include processing resources for executing machine-executable code, such as a central processing unit (CPU), a programmable logic array (PLA), an embedded device such as a System-on-a-Chip (SoC), or other control logic hardware. Information handling system 600 can also include one or more computer-readable medium for storing machine-executable code, such as software or data. Additional components of information handling system 600 can include one or more storage devices that can store machine-executable code, one or more communications ports for communicating with external devices, and various input and output (I/O) devices, such as a keyboard, a mouse, and a video display. Information handling system 600 can also include one or more buses operable to transmit information between the various hardware components.

Information handling system 600 can include devices or modules that embody one or more of the devices or modules described below and operate to perform one or more of the methods described below. Information handling system 600 includes a processors 602 and 604, an input/output (I/O) interface 610, memories 620 and 625, a graphics interface 630, a basic input and output system/universal extensible firmware interface (BIOS/UEFI) module 640, a disk controller 650, a hard disk drive (HDD) 654, an optical disk drive (ODD) 656, a disk emulator 660 connected to an external solid state drive (SSD) 664, an I/O bridge 670, one or more add-on resources 674, a trusted platform module (TPM) 676, a network interface 680, a management device 690, and a power supply 695. Processors 602 and 604, I/O interface 610, memory 620, graphics interface 630, BIOS/UEFI module 640, disk controller 650, HDD 654, ODD 656, disk emulator 660, SSD 664, I/O bridge 670, add-on resources 674, TPM 676, and network interface 680 operate together to provide a host environment of information handling system 600 that operates to provide the data processing functionality of the information handling system. The host environment operates to execute machine-executable code, including platform BIOS/UEFI code, device firmware, operating system code, applications, programs, and the like, to perform the data processing tasks associated with information handling system 600.

In the host environment, processor 602 is connected to I/O interface 610 via processor interface 606, and processor 604 is connected to the I/O interface via processor interface 608. Memory 620 is connected to processor 602 via a memory interface 622. Memory 625 is connected to processor 604 via a memory interface 627. Graphics interface 630 is connected to I/O interface 610 via a graphics interface 632 and provides a video display output 636 to a video display 634. In a particular embodiment, information handling system 600 includes separate memories that are dedicated to each of processors 602 and 604 via separate memory interfaces. An example of memories 620 and 630 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 640, disk controller 650, and I/O bridge 670 are connected to I/O interface 610 via an I/O channel 612. An example of I/O channel 612 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 610 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 640 includes BIOS/UEFI code operable to detect resources within information handling system 600, to provide drivers for the resources, initialize the resources, and access the resources. BIOS/UEFI module 640 includes code that operates to detect resources within information handling system 600, to provide drivers for the resources, to initialize the resources, and to access the resources.

Disk controller 650 includes a disk interface 652 that connects the disk controller to HDD 654, to ODD 656, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits SSD 664 to be connected to information handling system 600 via an external interface 662. An example of external interface 662 includes a USB interface, an IEEE 4394 (Firewire) interface, a proprietary interface, or a combination thereof. Alternatively, solid-state drive 664 can be disposed within information handling system 600.

I/O bridge 670 includes a peripheral interface 672 that connects the I/O bridge to add-on resource 674, to TPM 676, and to network interface 680. Peripheral interface 672 can be the same type of interface as I/O channel 612 or can be a different type of interface. As such, I/O bridge 670 extends the capacity of I/O channel 612 when peripheral interface 672 and the I/O channel are of the same type, and the I/O bridge translates information from a format suitable to the I/O channel to a format suitable to the peripheral channel 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board or add-in card disposed within information handling system 600, a device that is external to the information handling system, or a combination thereof.

Network interface 680 represents a NIC disposed within information handling system 600, on a main circuit board of the information handling system, integrated onto another component such as I/O interface 610, in another suitable location, or a combination thereof. Network interface device 680 includes network channels 682 and 684 that provide interfaces to devices that are external to information handling system 600. In a particular embodiment, network channels 682 and 684 are of a different type than peripheral channel 672 and network interface 680 translates information from a format suitable to the peripheral channel to a format suitable to external devices. An example of network channels 682 and 684 includes InfiniBand channels, Fibre Channel channels, Gigabit Ethernet channels, proprietary channel architectures, or a combination thereof. Network channels 682 and 684 can be connected to external network resources (not illustrated). The network resource can include another information handling system, a data storage system, another network, a grid management system, another suitable resource, or a combination thereof.

Management device 690 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 600. In particular, management device 690 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 600, such as system cooling fans and power supplies. Management device 690 can include a network connection to an external management system, and the management device can communicate with the management system to report status information for information handling system 600, to receive BIOS/UEFI or system firmware updates, or to perform other task for managing and controlling the operation of information handling system 600.

Management device 690 can operate off of a separate power plane from the components of the host environment so that the management device receives power to manage information handling system 600 when the information handling system is otherwise shut down. An example of management device 690 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 690 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A monitoring system comprising:
a memory; and
a controller coupled to the memory, the controller configured to:
configure a custom exporter to scrape metrics from each of a plurality of targeted pods in a distributed computing environment;
collect the metrics from each of the plurality of targeted pods;
store the collected metrics in the memory;
select one or more stored metrics associated with a pod to be processed;
compare the selected metrics with corresponding preconfigured thresholds associated with the pod to be processed;
generate a pre/post method for the pod, wherein the generated pre/post method is based at least upon the comparison between the selected metrics and the preconfigured thresholds associated with the pod; and
implement the generated pre/post method on the pod.

2. The monitoring system of claim 1, wherein the custom exporter is configured to collect the metrics from each of the plurality of targeted pods after a time period or upon an occurrence of an event.

3. The monitoring system of claim 2, wherein the custom exporter is configured to transform the collected metrics into Prometheus Query Language (PromQL) data.

4. The monitoring system of claim 1, wherein the stored metrics include time-series data.

5. The monitoring system of claim 1, wherein the custom exporter is configured to transmit the collected metrics for storing in response to a query from a Prometheus server.

6. The monitoring system of claim 1, wherein the controller is further configured to select the one or more stored metrics based on parameters of rules or conditions associated with the pod to be processed.

7. The monitoring system of claim 6, wherein the parameters include at least one of central processing unit (CPU) usage, data workload, read error rates, write error rates, and data dependencies.

8. The monitoring system of claim 1, wherein the determined pre/post method includes a combination of a base pre/post method and a derived pre/post method.

9. The monitoring system of claim 8, wherein the base pre/post method is implemented on the pod without regard to values or labels of the collected metrics.

10. The monitoring system of claim 8, wherein the derived pre/post method is based on the selected one or more stored metrics associated with a pod to be processed.

11. A method comprising:
configuring, by a controller, a custom exporter to scrape metrics from each of a plurality of targeted pods in a distributed computing environment;
collecting, by the controller, of the metrics from each of the plurality of targeted pods;
storing the collected metrics in the memory;
selecting one or more stored metrics associated with a pod to be processed;
comparing the selected metrics with preconfigured thresholds associated with the pod to be processed;
generating a pre/post method for the pod, wherein the generated pre/post method is based at least upon the comparison between the selected metrics and the preconfigured thresholds associated with the pod; and
implementing the generated pre/post method on the pod.

12. The method of claim 11, wherein the collecting the metrics from each of the plurality of targeted pods is performed after a time period or upon an occurrence of an event.

13. The method of claim 11, wherein the collected metrics include time-series data.

14. The method of claim 11, wherein the configuring the custom exporter includes configuring the custom exporter to transform the collected metrics into a Prometheus Query Language (PromQL) data.

15. The method of claim 11, wherein the selecting the one or more stored metrics is based on parameters associated with the pod to be processed.

16. The method of claim 15, wherein the parameters include at least one of central processing unit (CPU) usage, data workload, read error rates, write error rates, and data dependencies.

17. The method of claim 11, wherein the determined pre/post method includes a combination of a base pre/post method and a derived pre/post method.

18. An information handling system comprising:
a memory; and
a controller coupled to the memory, the controller configured to:
configure a custom exporter to scrape metrics from each of a plurality of targeted pods in a Kubernetes environment;
collect the metrics from each of the plurality of targeted pods;
store the collected metrics in the memory;
select one or more stored metrics associated with a pod to be processed;
generate a pre/post method for the pod using the selected one or more metrics associated with the pod; and
implement the generated pre/post method on the pod.

19. The information handling system of claim 18, wherein the controller is further configured to collect the metrics from each of the plurality of targeted pods after a time period or an occurrence of a condition.

20. The information handling system of claim 19, wherein the collected metrics include time-series data.
